(19) United States
(12) Patent Application Publication
(10) Pub. No.: US 2008/0001072 A1
(43) Pub. Date: Jan. 3, 2008

(54) Position detecting apparatus

(75) Inventor: Chin-Fu Chang, Tainan County (TW)

Correspondence Address: RADER FISHMAN & GRAUER PLLC, LION BUILDING, 1233 20TH STREET N.W., SUITE 501, WASHINGTON, DC, 20036, US

(73) Assignee: EGALAX_EMPIA TECHNOLOGY INC., Taipei City (TW)

(21) Appl. No.: 11/822,220

(22) Filed: Jul. 3, 2007

(30) Foreign Application Priority Data
Jul. 3, 2006 (TW) 95124209

(51) Int. Cl. G06M 7/00; H01J 40/14

(52) U.S. Cl. 250/221

(57) ABSTRACT

A position detecting apparatus is described, which includes a rectangular or square frame, divergent type light sources disposed on each of four corners of the frame to each emit a light signal, a plurality of light signal receivers including four sets of side light signal receivers disposed along one of four sides, respectively, to each receive the light signal, and a processor coupled to each of the plurality of light signal receivers. When an object touches on and within the frame, for each of the respective light sources, a portion of the light signal receivers of one or two neighboring ones of the four sets of side light signal receivers is blocked and has an decrease in an intensity of the received light signal, and the processor determines a specific position of the object based on a position of the plurality of light signal receivers each having the received light signal with the decreased intensity.

### FIELD OF INVENTION

The present invention generally relates to a position detecting apparatus, and more particularly, to a position detecting apparatus with high resolution, particularly useful when used with a touch panel.

### BACKGROUND OF THE INVENTION

Depending on different mechanisms, current available touch panels comprise resistive touch panels, capacitive touch panels, surface acoustic wave (SAW) touch panels and infrared (IR) touch panels. Among them, the capacitive touch panel is made of a glass substrate coated with an antimony tin oxide (ATO) film and silver paste lines thereon for their high stability, high transmittance of light and high surface hardness. However, the thus formed capacitive touch panel requires a high cost and a complicated manufacturing process. With related to the resistive touch panel, it is essentially composed of an indium tin oxide (ITO) conductive film and a sheet of ITO glass, lending itself to have a low production cost and a simplified structure. Nevertheless, the transmittance of light and surface hardness of the resistive touch panel are inferior to those of the capacitive one as mentioned above. The surface acoustic wave touch panel is a touch panel device which obtains coordinates of a position of an object touching thereon by emitting surface acoustic waves and then receiving and calculating amplitudes thereof. The Infrared touch panel is operated to determine a position of an object proximate thereto by arranging emitting and receiving devices around a screen of a display associated with the touch panel. When an object contacts the screen, light signals emitted from the emitting devices and associated with the object position are blocked. At this time, the coordinates of the position where the object is on the screen may be calculated by analyzing the signals received in the receiving devices.

FIG. 1 depicts schematically a position detecting apparatus used for the infrared touch panel according to the prior art. As shown, the position detecting apparatus 100 includes a frame 110 usually having a rectangular or square shape, a plurality of infrared light sources 131-137 and 141-147, and a plurality of light signal receivers 151-157 and 161-167. The light signal receivers 151-157 each receive a light emitted from the infrared light sources 131-137 respectively, and the light signal receivers 161-167 each receive the light emitted from the infrared light sources 141-147 respectively. When an object, e.g. a user's finger, 120 touches somewhere within the frame 110, for example, the light signal receivers 163 and 164 may not receive the light emitted from the light sources 143 and 144, and the light signal receivers 153 and 154 may not receive the light emitted from the light sources 133 and 134. At this time, the X-coordinate of the object 120 within the frame 110 may be determined by knowing the positions of the light signal receivers 153 and 154, and the Y-coordinate of the object 120 within the frame 110 by knowing the positions of the light signal receivers 163 and 164.

As can be known from FIG. 1, a resolution of the position detecting apparatus 100 is dependent on the number of the light sources. Nevertheless, the resolution of the position detecting apparatus 100 in FIG. 1 is relatively low as compared to that of each of the resistive touch panel, capacitive touch panel and surface acoustic wave (SAW) touch panels. This fact cannot allow the infrared touch panel itself to be utilized for high-end applications.

Consequently, there is a need to provide a position detecting apparatus with high resolution for an infrared touch panel so that the position of an object on the touch panel can be precisely detected.

### SUMMARY OF THE INVENTION

To effectively overcome the problems encountered in the prior art, the present invention provides a position detecting apparatus with high resolution, particularly useful when used with a touch panel for detecting a position of an object touching on the touch panel more precisely.

According to one aspect of the present invention, a position detecting apparatus is provided. The position detecting apparatus includes a frame having substantially a rectangular or square shape and having four corners and four sides, a light source being a divergent type light source and disposed on each of the four corners of the frame to each emit a light signal, wherein the respective light sources are sequentially activated by providing a scan signal thereonto, a plurality of light signal receivers including a first, second, third and fourth sets of side light signal receivers disposed along one of the four sides of the frame, respectively, to each receive the light signal from each of the respective light sources, and a processor coupled to each of the plurality of light signal receivers, wherein when an object is touched on and within the frame, a portion of the light signal receivers of one or two neighboring ones of the first, second, third and fourth sets of side light signal receivers for each of the respective light sources is blocked by the object and has an decrease in an intensity of the light signal for each of the respective light source, and the processor determines the specific position of the object based on a position of each one of the portion of the light signal receivers of the one or two neighboring ones of the first, second, third and fourth sets of side light signal receivers for each of the respective light sources by referring to the decrease in the intensity of the light signal for each of the light sources.

According to another aspect of the present invention, a method for determining a specific position of an object within a rectangular or square frame is provided. The method includes the steps of: disposing a light source being a divergent type light source on each of the four corners of the frame to each emit a light signal; driving the respective light sources to sequentially emit a light signal; disposing a plurality of light signal receivers including a first, second, third and fourth sets of side light signal receivers along one of the four sides of the frame, respectively, to each receive the light signal emitted from the respective light sources at the four corners of the frame; providing a processor to couple to each of the plurality of light signal receivers, blocking a portion of the light signal receivers of one or two neighboring ones of the first, second, third and fourth sets of side light signal receivers for each of the respective light sources by the object when the object is touched on and within the frame, and causing an decrease in an intensity on the light signal for each of the respective light sources by the blocking; and determining the specific position of the object based on a position of each one of the portion of the light signal receivers of the one or two neighboring ones of the first, second, third and fourth sets of side light signal receivers for each of the respective light sources by referring to the decrease in the intensity of the light signal for each of the respective light sources.

In an embodiment, the position detecting apparatus and the method for determining a specific position of an object within a rectangular or square frame are particularly used with an infrared (IR) touch panel.

Parts of other aspects of the present invention would be given in the following descriptions, which could easily be derived from the descriptions or from the implementations of the present invention. Each aspect of the present invention could be understood and achieved by the specified elements and combinations thereof in the appended claims. It should be appreciated that the summary recited above and the following detailed description are only illustrative but not for limiting the scope of the present invention.

### BRIEF DESCRIPTION OF THE DRAWINGS

The drawings as a part of the specification are used for illustrating the embodiments of the present invention and for explaining the principles of the present invention in conjunction with the specification. The recited embodiments are preferred embodiments of the present invention, however, it should be realized that the present invention is not limited to those shown arrangements and elements, wherein:

FIG. 1 is a schematic configuration of a position detecting apparatus for an infrared (IR) touch panel according to the prior art;

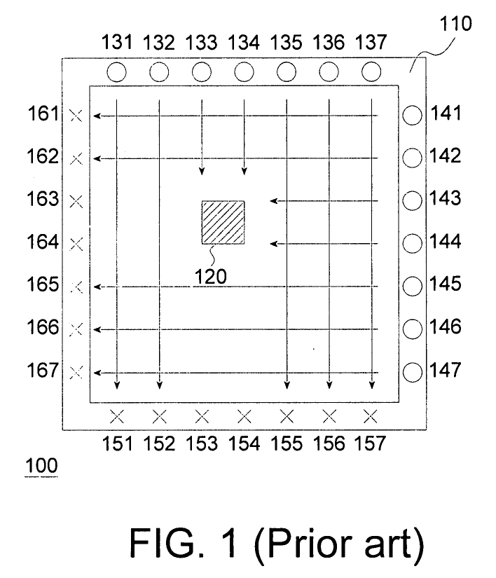

FIG. 2 is a schematic configuration of a position detecting apparatus according to the present invention;

FIG. 3 is a schematic diagram of a touch panel, particularly an infrared (IR) touch panel, applied with the position detecting apparatus according to the present invention thereon;

FIG. 4 is a schematic diagram illustrating how a position detecting apparatus according to the present invention is operated; and

FIG. 5 is a flow chart of a method for determining a specific position of an object within a rectangular or square frame according to the present invention.

### DETAILED DESCRIPTION OF THE INVENTION

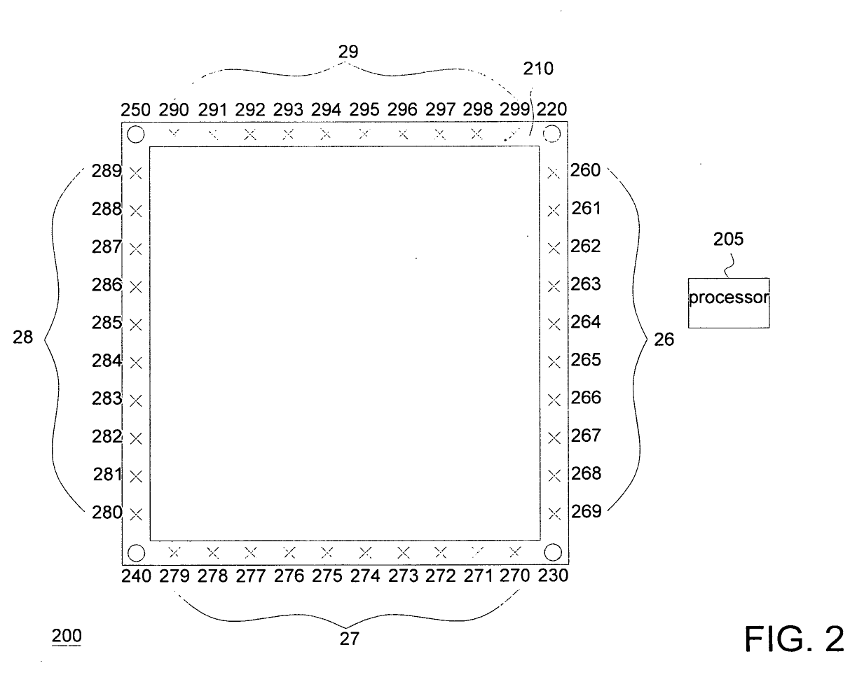

The present invention discloses a position detecting apparatus with high resolution. Referring to the following descriptions of the preferred embodiments in connection with FIG. 2 to FIG. 5, objects, embodiments, features and advantages of the present invention will be more obvious. However, the following devices, elements and methods recited in the embodiments are not provided in a limiting sense on the scope of the present invention but merely for illustration of the present invention.

FIG. 2 depicts a position detecting apparatus 200 according to the present invention. As shown, the position detecting apparatus 200 includes a processor 205, a frame 210, four light sources 220, 230, 240, and 250, and a plurality of light signal receivers 260-299. The frame 210 typically takes a substantially rectangular or square form and has four corners and four sides. Each of the light sources 220, 230, 240 and 250 is a divergent type light source, e.g. a point light source, and disposed on the four corners of the rectangular or square frame respectively for emitting a wide-angle light signal. In operation, the light sources 220, 230, 240 and 250 are each supplied with a scan signal to drive them to sequentially emit the light signal. The light signal receivers 260-299 are disposed along the four sides of the frame 210 to each receive the light signal emitted from the light sources 220, 230, 240, and 250 which the respective light signal receivers 260-299 can receive. Specifically, the light signal receivers 260-299 are, preferably averagely, disposed on the four sides of the frame 210, respectively, forming a first, second, third and third set of side light signal receivers 26, 27, 28, 29. Normally, the light signal emitted from each of the light sources 220, 230, 240 and 250 is received by two of the first, second, third and third set of side light signal receivers 26, 27, 28, 29 located on the two sides of the frame 210 having no contact with the light sources 220, 230, 240 and 250. The actual number of the light signal receivers 260-299 disposed on each side of the frame 210 varies with a required precision with respect to the position determination. Usually, the more the light signal receivers are, the higher the precision is. The processor 205 is coupled (although the coupling is not shown) to each of the light signal receivers 260-299 for analyzing an intensity of the light signal received by each of the light signal receivers 260-299 for each of the light sources 220, 230, 240, and 250 to calculate a specific position where an object touches on and within the frame. As the general practice, the processor 205 may cooperate with an analog-to-digital (A/D) converter or some known circuits to process the received signals in the light signal receivers 260-299.

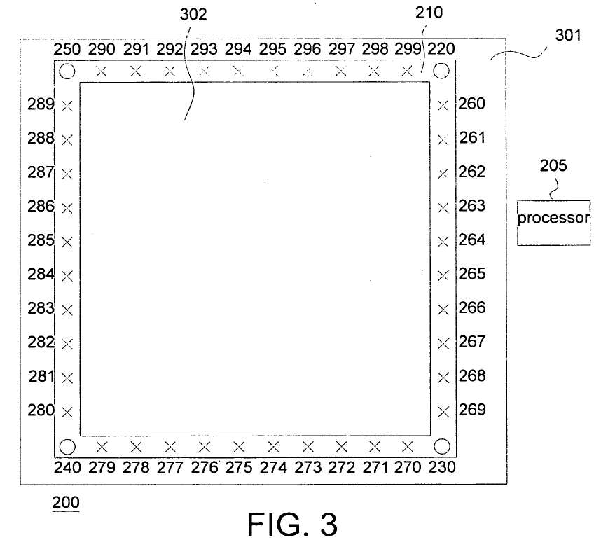

Particularly, the position detecting apparatus 200 may be used with a touch panel, as shown in FIG. 3. In this case, with reference to FIG. 2 and FIG. 3 concurrently, the light signal receivers 260-299 are circumferentially disposed about a screen 302 of a display 301 and the frame 210 is disposed on the screen 302 of the display 301. The display 301 can be any known display, such as liquid crystal display, CRT, etc. When the position detecting apparatus 200 is used together with a display 301, the processor 205 establishes a relationship between an array of surface positions (not shown) of the screen 302 (or positions of images shown on the screen 302) and an array of touch positions (not shown) within the frame 210. At this time, by acquiring the position of an object touching on and within the frame 210, a corresponding position among the array of on surface positions on the screen 302 can be determined. In a particular embodiment, each of the light sources 220, 230, 240 and 250 emits an infrared (IR) light signal and the touch panel shown in FIG. 3 is an IR touch panel. However, the light signal may take any of other forms, as long as the adopted light signal does not interfere with the displayed images on the screen 302.

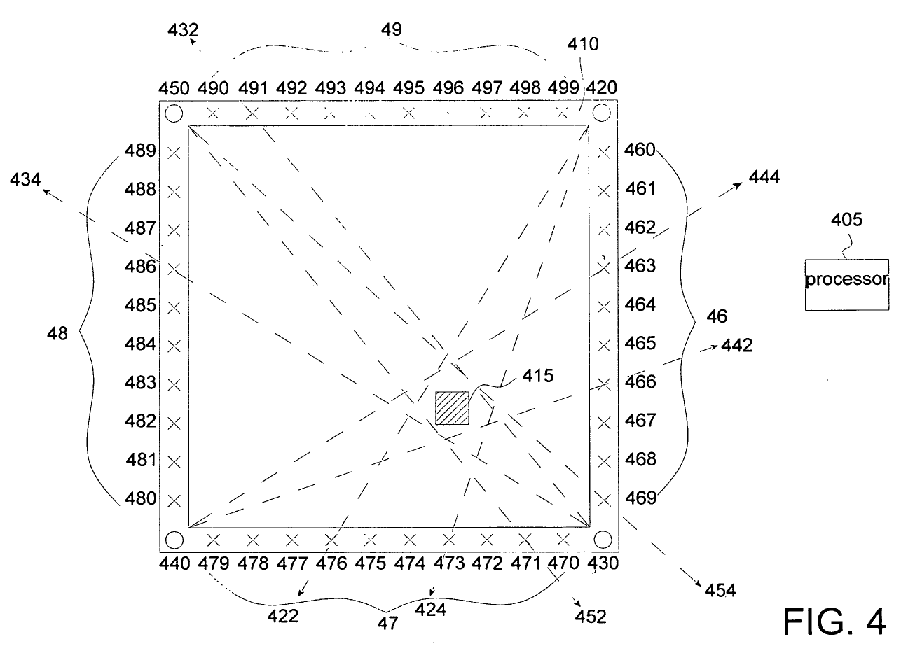

FIG. 4 depicts a schematic diagram illustrating how a position detecting apparatus according to the present invention is operated. In this embodiment, the position detecting apparatus 400 includes a processor 405, a frame 410 having a substantially rectangular or square shape having four corners and four sides, light sources 420, 430, 440 and 450, and a plurality of light signal receivers 460-499. The light sources 420, 430, 440 and 450 are divergent type light sources. In operation, the light sources 420, 430, 440 and 450 are each supplied with a scan signal to drive them to sequentially emit the light signal. The position detecting apparatus 400 may also be used with an IR touch panel. In fact, the position detecting apparatus 400 is identical to the position detecting apparatus 200 and thus its operation principle and arrangement of the frame 410, the light sources 420, 430, 440 and 450, and the light signal receivers 460-499 are entirely the same as those shown in FIG. 2, and not elaborated herein again.

When an object 415 is touched on and within the frame 410, a portion of the light signal emitted by each of the light sources 420, 430, 440, 450 is blocked and has a decrease in an intensity of the light signal for each of the respective light source. In fact, a portion of the light signal receivers 460-499 at one or two neighboring sides among the four sides of the frame 410 is blocked to receive the light signal from each of the light sources 420, 430, 440, 450. For example, when the light source 440 is activated, some of the light signal receivers 450-499 on one of the two sides of the frame 410 corresponding, respectively, to the first and fourth sets of side light signal receivers 46, 49 is blocked to receive the light signal from the light source 440.

Accordingly, an intensity of the light signal received by a portion of the plurality of light signal receivers 460-499 associated with the object 401 and each of the light source 420, 430, 440, 450 decreases, as compared to that before the object 415 touches on and within the frame 410. The processor 405 is coupled to each of the light signal receivers 460-499 for analyzing the intensity of the light signal received in each of the light signal receivers 460-499 for each of the light sources 420, 430, 440, 450. When the object 415 appears, the portion of the plurality of light signal receivers 460-499 having the decreased intensity is determined and a position of such light signal receivers 460-499 is found. By referring to the position of each of the light signal receivers having the decreased intensity for each of the light sources 420, 430, 440, 450, the processor 405 determines the specific position of the object 415.

In an implementation, the portion of one or two the first, second, third and fourth sets of side light signal receivers 46-49 for each of the light sources 420, 430, 440, 450 each having the decreased intensity has two ends, and the processor first defines a first and second outmost light signal receivers for the portion of the one or two neighboring ones of the first, second, third and fourth sets of side light signal receivers 46-49 for each of the light sources 420, 430, 440, 450. The first and second outmost light signal receivers are respectively defined as the light signal receiver located at one and the other of the two ends of the portion of the one or two neighboring ones of the first, second, third and fourth sets of side light signal receivers 46-49 for each of the light sources 420, 430, 440, 450. In the drawing, for example, when the light source 440 is activated, the first and second outmost light signal receivers are the light signal receivers 364, 366. Then, the processor 405 further defines a first and second virtual connection lines for each of the respective light sources 420, 430, 440, 450. The first and second virtual connection lines are respectively defined as a virtual connection line extending between the first and second outmost light signal receivers of the portion of the one or two neighboring ones of the first, second, third and fourth sets of side light signal receivers 46-49 for each of the respective light sources 420, 430, 440, 450 and the respective light sources 420, 430, 440, 450, respectively. In the drawing, for example, when the light source 440 is activated, the first and second virtual connection lines are 444 and 442. Further, the processor 405 also defines a reference area as a crossing area of the first and second virtual connection lines for each of the light sources 420, 430, 440, 450. Based on information of the reference area 420, the specific position of the object 415 can be determined.

In an implementation, the portion of one or two the first, second, third and fourth sets of side light signal receivers 46-49 for each of the light sources 420, 430, 440, 450 each having the decreased intensity has two ends, and the processor first defines a first and second outmost light signal receivers for the portion of the one or two neighboring ones of the first, second, third and fourth sets of side light signal receivers 46-49 for each of the light sources 420, 430, 440, 450. The first and second outmost light signal receivers are respectively defined as the light signal receiver located at one and the other of the two ends of the portion of the one or two neighboring ones of the first, second, third and fourth sets of side light signal receivers 46-49 for each of the light sources 420, 430, 440, 450. In the drawing, for example, when the light source 440 is activated, the first and second outmost light signal receivers are the light signal receivers 364, 366. Then, the processor 405 further defines a first and second virtual connection lines for each of the respective light sources 420, 430, 440, 450. The first and second virtual connection lines are respectively defined as a virtual connection line extending between the first and second outmost light signal receivers of the portion of the one or two neighboring ones of the first, second, third and fourth sets of side light signal receivers 46-49 for each of the respective light sources 420, 430, 440, 450 and the respective light sources 420, 430, 440, 450, respectively. In the drawing, for example, when the light source 440 is activated, the first and second virtual connection lines are lines 442 and 444 in the drawing. Likewise, the first and second virtual connection lines 422, 424 and 432, 434 and 452, 454 are made for the light source 420, 430 and 450. Further, the processor 405 also defines a reference area as a crossing area of the first and second virtual connection lines for each of the light sources 420, 430, 440, 450. Based on information of the reference area 420, the specific position of the object 415 can be determined.

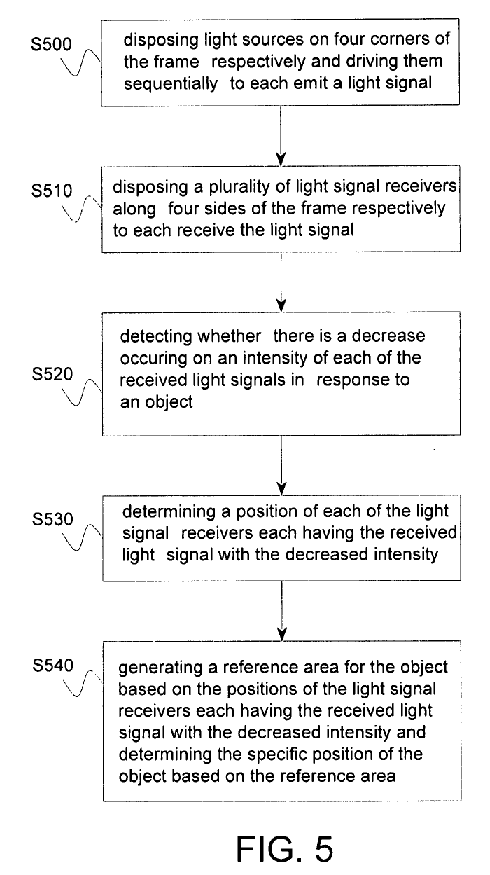

FIG. 5 is a flow chart of a method for determining a specific position of an object touching on and within a rectangular or square frame according to the present invention, which can be applied onto the above mentioned position detecting apparatuses. First, in step S500, each of four light sources is disposed on four corners of the frame, respectively, and drived to sequentially emit wide-angle light signals by, for example, a scan signal coupled thereto. In step S510, a plurality of light signal receivers including a first, second, third and fourth sets of side light signal receivers are disposed along one of the four sides of the frame, respectively, to each receive the light signal emitted from the respective light sources at the four corners of the frame. A processor is provided to couple to each of the plurality of light signal receivers. When the object is touched on and within the frame, a portion of the light signal receivers of one or two neighboring ones of the first, second, third and fourth sets of side light signal receivers for each of the respective light sources is blocked by the object, which results in an decrease in an intensity on the light signal for each of the respective light sources by the blocking. In step S520, the decrease in the intensity of the light signal for each of the respective light sources is detected. Then in step S530, a position of each one of the portion of the light signal receivers of the one or two neighboring ones of the first, second, third and fourth sets of side light signal receivers for each of the respective light sources is determined by referring to the decrease in the intensity of the light signal for each of the respective light sources. In step S540, a first and second outmost light signal receivers of the portion of the one or two neighboring ones of the first, second, third and fourth sets of side light signal receivers for each of the respective light sources which locate at one and the other ends of the portion of the one or two neighboring ones of the first, second, third and fourth sets of side light signal receivers for each of the respective light sources, are defined respectively. A first and second virtual connection lines for each of the respective light sources as extending between the first and second outmost light signal receivers of the portion of the light signal receivers of the one or two neighboring ones of the first, second, third and fourth sets of side light signal receivers for each of the respective light sources and the respective light sources may be defined. A reference area as a crossing area of the first and second virtual connection lines for each of the respective light sources may further be defined. Then, the specific position of the object is determined based on the reference area. In the above process, Steps S530 and S540 may be completed by a processor executing a specific algorithm including codes associated therewith.

The method shown in FIG. 5 is applicable to general displays requiring a touch input means and realizes touch panels with high resolution. In this case, the frame is disposed on a screen of a display and forming a touch panel, particularly an IR touch panel. A relationship between a plurality of surface positions of the screen and a plurality of touch positions comprising the specific position within the frame is established. Accordingly, the specific position obtained by step S540 may determine the portion of the displayed image selected by a user. As compared to the conventional position detecting apparatus of the infrared touch panel that determines the touch position by using two sets of virtual connection lines (X and Y directions), the present invention can determine the touch position more precisely, since the fourth sets of virtual connection lines are generated to assist in the touch position.

The above description is given with the preferred embodiments and only for illustration and not intended to limit the scope of the present invention. Any other equivalent changes or modifications not departing from the spirit of the present invention should be included in the appended claims.

What is claimed is:

1. A position detecting apparatus, comprising:
a frame having substantially a rectangular or square shape and having four corners and four sides;
a light source being a divergent type light source and disposed on each of the four corners of the frame to each emit a light signal, wherein the respective light sources are sequentially activated by providing a scan signal thereonto;
a plurality of light signal receivers, including a first, second, third and fourth sets of side light signal receivers disposed along one of the four sides of the frame, respectively, to each receive the light signal from each of the respective light sources; and
a processor coupled to each of the plurality of light signal receivers,
wherein when an object is touched on and within the frame, a portion of the light signal receivers of one or two neighboring ones of the first, second, third and fourth sets of side light signal receivers for each of the respective light sources is blocked by the object and has an decrease in an intensity of the light signal for each of the respective light source, and the processor determines a specific position of the object based on a position of each one of the portion of the light signal receivers of the one or two neighboring ones of the first, second, third and fourth sets of side light signal receivers for each of the respective light sources by referring to the decrease in the intensity of the light signal for each of the respective light sources.

2. The position detecting apparatus as claimed in claim 1, wherein the portion of the one or two neighboring ones of the first, second, third and fourth sets of side light signal receivers for each of the respective light sources has respective two ends, the processor defines a first and second outmost light signal receivers of the portion of the one or two neighboring ones of the first, second, third and fourth sets of side light signal receivers for each of the respective light sources which locate at one and the other of the respective two ends of the portion of the one or two neighboring ones of the first, second, third and fourth sets of side light signal receivers for each of the respective light sources, respectively, defines a first and second virtual connection lines for each of the respective light sources as extending between the first and second outmost light signal receivers of the portion of the one or two neighboring ones of the first, second, third and fourth sets of side light signal receivers for each of the respective light sources and the respective light sources, respectively, defines a reference area as a crossing area of the first and second virtual connection lines for each of the respective light sources, and determining the specific position of the object based on the reference area.

3. The position detecting apparatus as claimed in claim 1, wherein the plurality of light signal receivers are substantially averagely disposed along the four sides of the square or rectangular frame.

4. The position detecting apparatus as claimed in claim 1, wherein the light source is a point light source.

5. The position detecting apparatus as claimed in claim 1, wherein the position detecting apparatus is used with a display having a screen and is circumferentially disposed about the screen.

6. The position detecting apparatus as claimed in claim 5, wherein the position detecting apparatus is used with an infrared touch panel and the light source is an infrared (IR) light source.

7. A method for determining a specific position of an object touching on and within a frame being substantially a rectangular or square frame having four corners and four sides, comprising the steps of:
disposing a light source being a divergent type light source on each of the four corners of the frame to each emit a light signal;
driving the respective light sources to sequentially emit a light signal;
disposing a plurality of light signal receivers including a first, second, third and fourth sets of side light signal receivers along one of the four sides of the frame, respectively, to each receive the light signal emitted from the respective light sources at the four corners of the frame;
providing a processor to couple to each of the plurality of light signal receivers,
blocking a portion of the light signal receivers of one or two neighboring ones of the first, second, third and fourth sets of side light signal receivers for each of the respective light sources by the object when the object is touched on and within the frame, and causing an decrease in an intensity on the light signal for each of the respective light sources by the blocking; and
determining the specific position of the object based on a position of each one of the portion of the light signal receivers of the one or two neighboring ones of the first, second, third and fourth sets of side light signal receivers for each of the respective light sources by referring to the decrease in the intensity of the light signal for each of the respective light sources.

8. The method as claimed in claim 7, further comprising the steps, before the step of determining of:
defining a first and second outmost light signal receivers of the portion of the one or two neighboring ones of the first, second, third and fourth sets of side light signal receivers for each of the respective light sources which locate at one and the other ends of the portion of the one or two neighboring ones of the first, second, third and fourth sets of side light signal receivers for each of the respective light sources, respectively;
defining a first and second virtual connection lines for each of the respective light sources as extending between the first and second outmost light signal receivers of the portion of the light signal receivers of the one or two neighboring ones of the first, second, third and fourth sets of side light signal receivers for each of the respective light sources and the respective light sources;
defining a reference area as a crossing area of the first and second virtual connection lines for each of the respective light sources; and
determining the specific position of the object based on the reference area.

9. The method as claimed in claim 7, wherein the plurality of light signal receivers are substantially averagely disposed along the four sides of the frame.

10. The method as claimed in claim 7, wherein the divergent type light source is a point light source.

11. The method as claimed in claim 7, wherein the divergent type light source is an infrared (IR) light source.

12. The method as claimed in claim 11, further comprising the steps of:
disposing the frame on a screen of a display and forming an IR touch panel; and
establishing a relationship between a plurality of surface positions of the screen and a plurality of touch positions comprising the specific position within the frame.
